(19) United States
(12) Patent Application Publication
(10) Pub. No.: US 2026/0126092 A1
(43) Pub. Date: May 7, 2026

(54) Vibration Isolation Mechanism

(71) Applicant: NOK CORPORATION, Tokyo (JP)

(72) Inventors: Shunsuke TSUYUKI, Tottori (JP); Toi MATSUMOTO, Tottori (JP)

(21) Appl. No.: 19/269,401

(22) Filed: Jul. 15, 2025

(30) Foreign Application Priority Data
Nov. 1, 2024 (JP) 2024-193017

(51) Int. Cl. F16F 1/38

(52) U.S. Cl. CPC F16F 1/3828; F16F 2230/0005; F16F 2230/02

(57) ABSTRACT

An anti-vibration mount includes: an inner member for insertion of a shaft; an outer member surrounding the inner member; and a resilient body including a covering portion covering an outer peripheral surface of the inner member, a connecting portion connecting the inner member with the outer member, and a first engagement portion formed on an outer peripheral surface of the covering portion. A restricting member includes: a support for insertion of the shaft; and a resilient body formed on the support and including a facing surface with a restriction region spaced apart and facing an end surface of the outer member, a groove portion formed in the facing surface and extending along a circumferential direction of the shaft, an inner peripheral surface facing the outer peripheral surface of the covering portion, and a second engagement portion formed on the inner peripheral surface and engaging with the first engagement portion.

### CROSS REFERENCE TO RELATED APPLICATION

This Application is based on, and claims priority from, Japanese Patent Application No. 2024-193017, filed Nov. 1, 2024, the entire content of which is incorporated herein by reference.

### TECHNICAL FIELD

The present disclosure relates to vibration isolation mechanisms.

### BACKGROUND

A vibration isolation mechanism for reducing the transmission of vibration between a first member and a second member has been conventionally proposed. For example, Japanese Patent No. 7286009 discloses an anti-vibration bush including an upper bush and a lower bush. In the configuration of Japanese Patent No. 7286009, the lower bush is mounted to the upper bush through engagement between an annular protrusion formed on a first resilient body of the upper bush and a non-annular protrusion formed on a second resilient body of the lower bush.

### SUMMARY

In a vibration isolation mechanism constituted by a combination of a plurality of members such as the upper bush and the lower bush in Japanese Patent No. 7286009, there is room for further improvement from the viewpoint of facilitating the work of assembling the plurality of members.

In one aspect, a vibration isolation mechanism includes: (a) an anti-vibration mount that includes: (i) an inner member into which a shaft member is to be inserted; (ii) an outer member surrounding the inner member; and (iii) a first resilient body that includes (1) a covering portion covering an outer peripheral surface of the inner member, (2) a connecting portion connecting the inner member with the outer member, and (3) a first engagement portion formed on an outer peripheral surface of the covering portion; and (b) a restricting member that includes: (i) a support member into which the shaft member is to be inserted; and (ii) a second resilient body provided on the support member, in which the second resilient body includes: (1) a facing surface including a restriction region that is spaced apart and faces an end surface of the outer member, (2) a groove portion formed in the facing surface and extending along a circumferential direction of the shaft member, (3) an inner peripheral surface facing the outer peripheral surface of the covering portion, and (4) a second engagement portion formed on the inner peripheral surface and engaging with the first engagement portion.

In another aspect, a vibration isolation mechanism includes: (a) a first restricting member; (b) a second restricting member; and (c) an anti-vibration mount between the first restricting member and the second restricting member, in which the anti-vibration mount includes: (i) an inner member into which a shaft member is to be inserted; (ii) an outer member surrounding the inner member; and (iii) a first resilient body that includes (1) a covering portion covering an outer peripheral surface of the inner member, (2) a connecting portion connecting the inner member with the outer member, and (3) a plurality of first engagement portions formed on an outer peripheral surface of the covering portion, each of the first restricting member and the second restricting member includes: (i) a support member into which the shaft member is to be inserted, and (ii) a second resilient body provided on the support member, the second resilient body includes: (1) a facing surface including a restriction region that is spaced apart and faces an end surface of the outer member; (2) a groove portion formed in the facing surface and extending along a circumferential direction of the shaft member; (3) an inner peripheral surface facing the outer peripheral surface of the covering portion, and (4) a second engagement portion formed on the inner peripheral surface, in which the second engagement portion of the first restricting member engages with, from among the plurality of first engagement portions, a first engagement portion located on one side of the connecting portion, and the second engagement portion of the second restricting member engages with, from among the plurality of first engagement portions, a first engagement portion located on another side of the connecting portion.

### BRIEF DESCRIPTION OF THE DRAWINGS

FIG. 1 is a cross-sectional view of a vibration isolation mechanism according to a first embodiment.

FIG. 2 is a cross-sectional view of an anti-vibration mount.

FIG. 3 is an enlarged cross-sectional view of a vicinity of an annular protrusion portion in the anti-vibration mount.

FIG. 4 is a plan view and a cross-sectional view of a restricting member.

FIG. 5 is an enlarged cross-sectional view of a vicinity of an annular recess portion in the restricting member.

FIG. 6 is an explanatory view of a step of mounting the restricting member to the anti-vibration mount.

FIG. 7 is an explanatory view of the step of mounting the restricting member to the anti-vibration mount.

FIG. 8 is an explanatory view of the step of mounting the restricting member to the anti-vibration mount.

FIG. 9 is an explanatory view of problems in a comparative example.

FIG. 10 is a cross-sectional view of a vibration isolation mechanism according to a second embodiment.

FIG. 11 is a partial cross-sectional view of a vibration isolation mechanism according to a modification.

FIG. 12 is a partial cross-sectional view of a vibration isolation mechanism according to a modification.

FIG. 13 is a partial cross-sectional view of a vibration isolation mechanism according to a modification.

FIG. 14 is a plan view of a restricting member according to a modification.

### DESCRIPTION OF THE EMBODIMENTS

Embodiments of the present disclosure will be described with reference to the drawings. In the drawings, the dimensions and scales of each element may be different from actual products. Also, the embodiments described below are exemplary forms envisioned when implementing the present disclosure. Therefore, the scope of the present disclosure is not limited to the following embodiments.

### A: First Embodiment

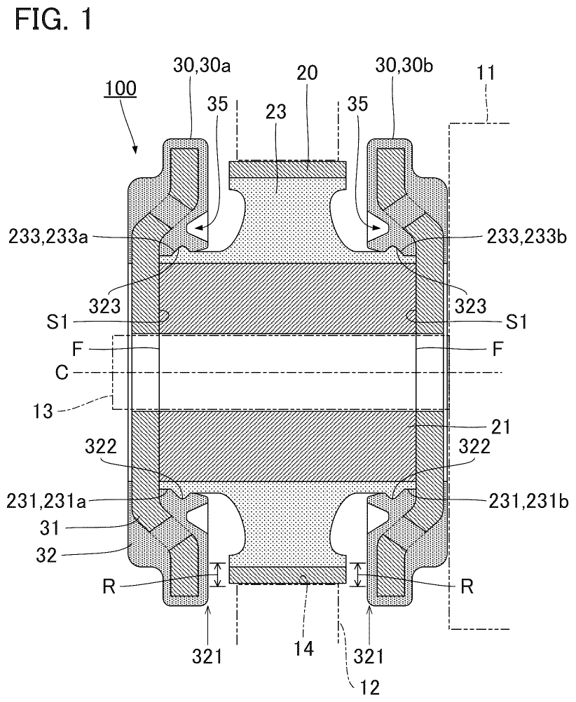

FIG. 1 is a cross-sectional view of a vibration isolation mechanism 100 according to a first embodiment. The vibration isolation mechanism 100 according to the first embodiment is installed between a first member 11 and a second member 12, and is a mechanism for reducing transmission of vibration between the first member 11 and the second member 12.

The first member 11 is, for example, a vehicle body frame in a moving body such as an electric vehicle. The vibration isolation mechanism 100 is fixed to the first member 11 by way of a shaft member 13 provided in the first member 11. The second member 12 is a housing of various auxiliary devices mounted on a moving body such as an electric vehicle. A housing of an auxiliary device such as a compressor or pump for cooling is an example of the second member 12. A circular mounting hole 14 is formed in the second member 12. The vibration isolation mechanism 100 is installed in the mounting hole 14 of the second member 12.

In the following description, a direction of a central axis C of the shaft member 13 is referred to as an axial direction. Furthermore, a direction along a circumference of a virtual circle having any diameter centered on the central axis C is referred to as a “circumferential direction”, and a direction of a radius of the virtual circle is referred to as a “radial direction”. In the radial direction, a direction opposite to the central axis C may be referred to as “radially outward”, and a direction toward the central axis C in the radial direction may be referred to as “radially inward”.

As illustrated in FIG. 1, the vibration isolation mechanism 100 includes an anti-vibration mount 20, a restricting member 30a, and a restricting member 30b. The anti-vibration mount 20, the restricting member 30a, and the restricting member 30b each are a structure having a shape of a body rotating about the central axis C of the shaft member 13, and are disposed coaxially with each other. The central axis C is also referred to as a central axis of the anti-vibration mount 20, the restricting member 30a, or the restricting member 30b.

The anti-vibration mount 20, the restricting member 30a, and the restricting member 30b are formed as separate bodies from one another. The restricting member 30a and the restricting member 30b are mounted to the anti-vibration mounts 20. Specifically, the anti-vibration mount 20 is provided between the restricting member 30a and the restricting member 30b. For example, the restricting member 30b is located between the anti-vibration mount 20 and the first member 11. A state in which the restricting member 30a and the restricting member 30b are mounted to the anti-vibration mount 20 is hereinafter referred to as a “mounted state”.

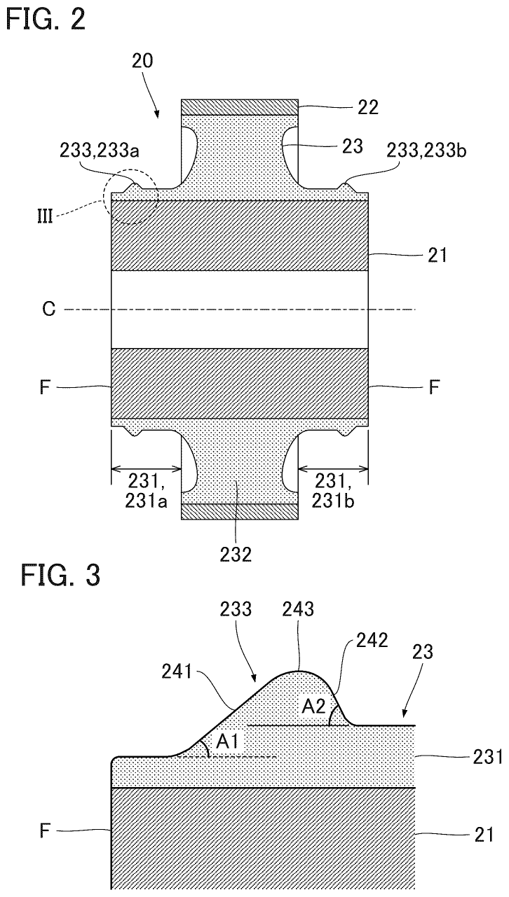

FIG. 2 is a cross-sectional view of the anti-vibration mount 20. As illustrated in FIG. 2, the anti-vibration mount 20 is a structure including an inner member 21, an outer member 22, and a first resilient body 23. The inner member 21, the outer member 22, and the first resilient body 23 are each formed to have a shape of a body rotating about the central axis C, and are disposed coaxially relative to each other.

The first resilient body 23 is formed of a resilient material such as a rubber material. Examples of the rubber material used for the first resilient body 23 include, but are not limited to, chloroprene rubber (CR), silicone rubber (SR), acrylic rubber (ACM), urethane rubber (U), polyurethane rubber (PUR), vinyl methyl silicone rubber (VMQ), ethylene propylene diene rubber (EPDM), and fluororubber (FKM). The first resilient body 23 may be formed of, for example, a resin material having low rigidity.

The inner member 21 and the outer member 22 are structures having higher rigidity than the first resilient body 23, and are formed of, for example, a metal material. Examples of the metal material used for the inner member 21 and the outer member 22 include, but are not limited to stainless steel, an SPCC (Steel Plate Cold Commercial), and an SPHC (Steel Plate Hot Commercial). The inner member 21 and the outer member 22 may be formed of, for example, a highly rigid resin material. In addition, the inner member 21 and the outer member 22 may be formed of the same type of material or may be formed of different types of material.

The inner member 21, the outer member 22, and the first resilient body 23 are integrally molded by injection molding (i.e., insert molding) using a molding mold such as a metal mold or a resin mold. That is, the anti-vibration mount 20 is a molded article in which the inner member 21, the outer member 22, and the first resilient body 23 are integrally formed.

The inner member 21 is a cylindrical structure into which the shaft member 13 is to be inserted. The inner diameter of the inner member 21 is substantially equal to the diameter of the shaft member 13. Each end surface F of the inner member 21 on either side in the axial direction is an annular plane perpendicular to the central axis C.

The outer member 22 is a cylindrical (or annular) member surrounding the inner member 21. That is, the outer peripheral surface of the inner member 21 and the inner peripheral surface of the outer member 22 are spaced apart from each other at a constant distance and face each other. The dimension of the outer member 22 in the axial direction is less than the dimension of the inner member 21 in the axial direction. The outer member 22 is provided at a position corresponding to the center of the inner member 21 in the axial direction. As illustrated in FIG. 1, the outer member 22 is press-fitted into the mounting hole 14 of the second member 12. That is, the outer peripheral surface of the outer member 22 is in close contact with the inner peripheral surface of the mounting hole 14.

As illustrated in FIG. 2, the first resilient body 23 includes a covering portion 231 (231a,231b), a connecting portion 232, and an annular protrusion portion 233 (233a,233b). The covering portion 231, the connecting portion 232, and the annular protrusion portion 233 are integrally formed from a resilient material by molding.

The covering portion 231 is a film-shaped portion that covers an outer peripheral surface of the inner member 21. The covering portion 231a covers a part of the inner member 21 that is adjacent to the restricting member 30a. The end surface of the covering portion 231a is located in the same plane as the end surface F of the inner member 21. The covering portion 231b covers a part of the inner member 21 that is adjacent to the restricting member 30b. The end surface of the covering portion 231b is located in the same plane as the end surface F of the inner member 21.

The annular protrusion portion 233 (233a,233b) is a protrusion formed on the outer peripheral surface of the covering portion 231. The annular protrusion portion 233 extends circumferentially. Specifically, the annular protrusion portion 233 is formed to have an annular shape that is continuous over the entire circumference of the covering portion 231 (or the inner member 21). The annular protrusion portion 233a is formed on the covering portion 231a, and the annular protrusion portion 233b is formed on the covering portion 231b.

FIG. 3 is an enlarged cross-sectional view of the annular protrusion portion 233 formed on the covering portion 231a. Region III of FIG. 2 is illustrated in FIG. 3. As illustrated in FIG. 3, the annular protrusion portion 233 includes an outer wall surface 241 and an outer wall surface 242. The outer wall surface 241 is a frustoconical side surface of the annular protrusion portion 233 and is adjacent to the end surface F of the inner member 21. On the other hand, the outer wall surface 242 is a frustoconical side surface of the annular protrusion portion 233 and is located on the opposite side of the outer wall surface 241 in the axial direction. A point at which the outer wall surface 241 and the outer wall surface 242 intersect each other is a top portion 243 of the annular protrusion portion 233.

FIG. 3 shows an inclination angle A1 of the outer wall surface 241 and an inclination angle A2 of the outer wall surface 242. The inclination angle A1 is an angle at which the outer wall surface 241 is inclined at an angle relative to the axial direction (A1<90 degrees). The inclination angle A2 is an angle at which the outer wall surface 242 is inclined at an angle to the axial direction (A2<90 degrees). As illustrated in FIG. 3, the inclination angle A1 of the outer wall surface 241 is less than the inclination angle A2 of the outer wall surface 242 (A1<A2).

As illustrated in FIG. 2, a connecting portion 232 is an annular portion that connects the inner member 21 with the outer member 22. The connecting portion 232 is located between the inner member 21 and the outer member 22 in the radial direction. The connecting portion 232 is located in the vicinity of the center of the inner member 21 in the axial direction. Specifically, the connecting portion 232 is positioned between the covering portion 231a and the covering portion 231b in the axial direction. That is, in the axial direction, the annular protrusion portion 233a is located on one side of the connecting portion 232 (the restricting member 30a side), and the annular protrusion portion 233b is located on the other side (the restricting member 30b side) of the connecting portion 232. The connecting portion 232 protrudes radially outward from an outer peripheral surface of the covering portion 231 toward the outer member 22. That is, the outer diameter of the connecting portion 232 is greater than the outer diameter of the covering portion 231. An outer peripheral surface of the connecting portion 232 is connected to an inner peripheral surface of the outer member 22.

In the above configuration, vibration may be caused in the first member 11 and the second member 12, for example, in the axial direction, the circumferential direction, or the radial direction. By the first resilient body 23 being deformed in conjunction with vibration of the first member 11, the vibration transmitted from the first member 11 to the second member 12 is damped. Similarly, by the first resilient body 23 being deformed in conjunction with vibration of the second member 12, the vibration transmitted from the second member 12 to the first member 11 is damped. Thus, the use of the first resilient body 23 of the anti-vibration mount 20 can reduce transmission of vibration between the first member 11 and the second member 12.

As will be understood from the above description, the outer member 22 of the anti-vibration mount 20 may be displaced in the axial direction relative to the inner member 21. As the amount of displacement of the outer member 22 relative to the inner member 21 increases, the first resilient body 23 may be excessively deformed. As a result, the first resilient body 23 may deteriorate or fracture due to excessive deformation. The restricting member 30a and the restricting member 30b in FIG. 1 are stoppers that restrict the axial displacement of the outer member 22. That is, the axial displacement of the outer member 22 is limited to between the restricting member 30a and the restricting member 30b.

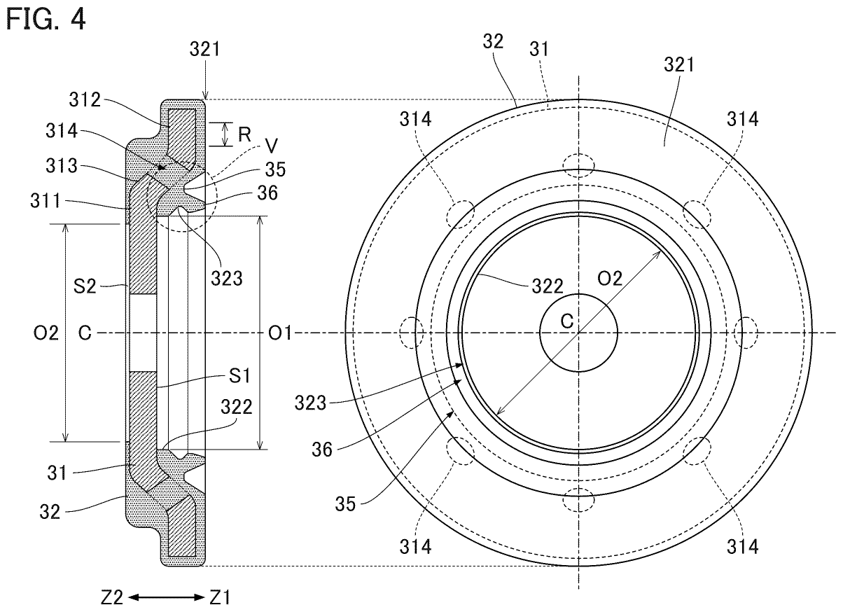

The configuration of the restricting member 30a and the configuration of the restricting member 30b are the same. Therefore, in the following description, both the restricting member 30a and the restricting member 30b will be described as “restricting member 30” without distinguishing the restricting member 30a and the restricting member 30b. Furthermore, in the following description, as illustrated in FIG. 4, the axial direction includes a Z1 direction and a Z2 direction oriented in opposite directions from each other. The Z1 direction is a direction from the restricting member 30 toward the anti-vibration mount 20.

FIG. 4 is a plan view and a cross-sectional view of the restricting member 30. As illustrated in FIG. 4, the restricting member 30 is a structure including a support member 31 and a second resilient body 32. The support member 31 and the second resilient body 32 are each formed to have a shape of a body rotating about the central axis C as the center, and are disposed coaxially with each other.

The second resilient body 32 is formed of a resilient material such as a rubber material. Examples of the rubber material used for the second resilient body 32 include, but are not limited to, chloroprene rubber (CR), silicone rubber (SR), acrylic rubber (ACM), urethane rubber (U), polyurethane rubber (PUR), vinyl methyl silicone rubber (VMQ), ethylene propylene diene rubber (EPDM), and fluororubber (FKM). The second resilient body 32 may be formed of, for example, a resin material having low rigidity. In addition, the first resilient body 23 and the second resilient body 32 may be formed of the same type of material having substantially the same resiliency characteristics, or may be formed of different types of materials having different resiliency characteristics.

The support member 31 is a structure having higher rigidity than the second resilient body 32, and is made of, for example, a metal material. Examples of the metal material used for the support member 31 include, but are not limited to stainless steel, an SPCC (Steel Plate Cold Commercial), and an SPHC (Steel Plate Hot Commercial). The support member 31 may be made of, for example, a highly rigid resin material. It is to be noted that the support member 31 and the inner member 21 or the outer member 22 may be formed of the same type of material or may be formed of different types of materials.

The second resilient body 32 is provided on the support member 31. Specifically, the support member 31 and the second resilient body 32 are integrally molded by injection molding (i.e., insert molding) using a molding mold such as a metal mold or a resin mold. That is, the restricting member 30 is a molded article in which the support member 31 and the second resilient body 32 are integrally formed.

The support member 31 is an annular structure into which the shaft member 13 is to be inserted. Specifically, the support member 31 is a flat member along a plane perpendicular to the central axis C. The support member 31 includes a first surface S1 and a second surface S2. The first surface S1 is a Z1-direction facing surface. The second surface S2 is a Z2-direction facing surface. The support member 31 according to the first embodiment is a structure in which a base portion 311, an outer peripheral portion 312, and a connecting portion 313 are integrally formed. For example, the support member 31 is formed by pressing a metal plate formed to have an annular shape.

The base portion 311 is an annular portion into which the shaft member 13 is to be inserted. The inner diameter of the base portion 311 is substantially equal to the diameter of the shaft member 13 (or the inner diameter of the inner member 21). The outer peripheral portion 312 is an annular portion located radially outward of the base portion 311 when viewed in the axial direction. The connecting portion 313 is an annular portion that connects the base portion 311 with the outer peripheral portion 312. As illustrated in the cross-sectional view of FIG. 4, the outer peripheral portion 312 is located in the Z1 direction relative to the base portion 311 in the axial direction. Accordingly, the connecting portion 313 is inclined at a predetermined angle relative to the central axis C. That is, the connecting portion 313 has a frustoconical shape.

As illustrated in FIG. 4, a plurality of through holes 314 is formed in the connecting portion 313. Specifically, the plurality of through holes 314 is arranged at equal intervals in the circumferential direction. Each of the plurality of through holes 314 is used as a flow path through which a liquid resilient material that will form the second resilient body 32 passes in the step of forming the restricting member 30 by using a molding mold. Since the second resilient body 32 passes through the through holes 314, the second resilient body 32 is fixed to the support member 31 as a result. The number and the positions of the through holes 314 may be freely changed.

The second resilient body 32 covers the outer peripheral portion 312, the connecting portion 313, and a radially outer portion of an annular region of the base portion 311, the portion being adjacent to the outer periphery. In the second resilient body 32A, a circular opening O2 is formed in a portion located in the Z2-direction side of the base portion 311. A part of the second surface S2 of the support member 31 (specifically, the base portion 311) is exposed through the opening O2 of the second resilient body 32. The second resilient body 32 may cover the entire second surface S2 of the support member 31.

As illustrated in FIG. 4, the second resilient body 32 includes a facing surface 321 and an inner peripheral surface 322. The facing surface 321 is an annular face of the second resilient body 32 that faces the Z1 direction. The facing surface 321 faces the outer member 22 of the anti-vibration mount 20 in a state in which the restricting member 30 is mounted to the anti-vibration mount 20. As illustrated in FIG. 1, the facing surface 321 includes an annular region (hereafter, a “restriction region R”) spaced apart and faces the end surface of the outer member 22 of the anti-vibration mount 20.

The restriction region R is a region with which the end surface of the outer member 22 comes into contact, when the outer member 22 moves in the axial direction relative to the inner member 21. As described above, when the outer member 22 comes into contact with the facing surface 321 of the second resilient body 32, the displacement of the outer member 22 in the axial direction is restricted. Therefore, as described above, it is possible to reduce a likelihood that the first resilient body 23 will fracture due to excessive deformation. Furthermore, the restriction region R is formed on the second resilient body 32. When displaced, the outer member 22 collides with the restriction region R formed in the second resilient body 32. Therefore, the collision noise of the outer member 22 can be suppressed as compared with a configuration in which the outer member 22 collides with the support member 31 having high rigidity.

As illustrated in FIG. 4, a circular opening O1 is formed in a portion of the second resilient body 32 located on the Z1-direction side of the base portion 311. A part of the first surface S1 of the support member 31 (specifically, the base portion 311) is exposed through the opening O1 of the second resilient body 32. The first surface S1 of the support member 31 is in contact with the end surface F of the inner member 21 of the anti-vibration mount 20 in the mounted state. The inner peripheral surface 322 of the second resilient body 32 is an inner wall surface defining the opening O1. Specifically, the inner peripheral surface 322 of the second resilient body 32 is a cylindrical surface concentric with the central axis C.

As illustrated in FIG. 1, in the mounted state, the inner peripheral surface 322 of the second resilient body 32 faces the outer peripheral surface of the covering portion 231 of the anti-vibration mount 20. For example, the inner peripheral surface 322 of the second resilient body 32 in the restricting member 30a faces the outer peripheral surface of the covering portion 231a, and the inner peripheral surface 322 of the second resilient body 32 in the restricting member 30b faces the outer peripheral surface of the covering portion 231b. The inner diameter of the inner peripheral surface 322 of the second resilient body 32 is substantially equal to the outer diameter of the covering portion 231 of the anti-vibration mount 20. Therefore, in the mounted state, the inner peripheral surface 322 of the second resilient body 32 and the outer peripheral surface of the covering portion 231 come into contact with each other. The inner diameter of the inner peripheral surface 322 of the second resilient body 32 may be set smaller than the outer diameter of the covering portion 231, so that the inner peripheral surface 322 of the second resilient body 32 and the outer peripheral surface of the covering portion 231 are closely fitted to each other with an increased interference allowance.

As illustrated in FIG. 4, an annular recess portion 323 is formed in the inner peripheral surface 322 of the second resilient body 32. The annular recess portion 323 is a recess extending along the circumferential direction. Specifically, the annular recess portion 323 is formed to have an annular shape that is continuous over the entire circumference of the inner peripheral surface 322. As illustrated in FIG. 1, the annular recess portion 323 is formed in the inner peripheral surface 322 of the second resilient body 32 at a position facing the annular protrusion portion 233 of the anti-vibration mount 20 in the mounted state.

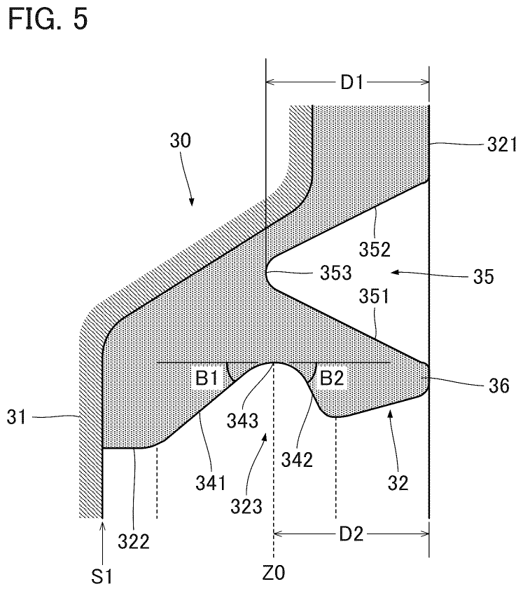

FIG. 5 is an enlarged cross-sectional view of the vicinity of the annular recess portion 323 of the restricting member 30. A region V in FIG. 4 is illustrated in FIG. 5. As shown in FIG. 5, the annular recess portion 323 includes an inner wall surface 341 and an inner wall surface 342. The inner wall surface 341 is a side surface adjacent to the support member 31 and having a frustoconical shape. On the other hand, the inner wall surface 342 is a frustoconical side surface of the annular recess portion 323 and located on the side opposite to the inner wall surface 342 in the axial direction. A point at which the inner wall surface 341 and the inner wall surface 342 intersect with each other is a bottom portion 343 of the annular recess portion 323.

In FIG. 5, an inclination angle B1 of the inner wall surface 341 and an inclination angle B2 of the inner wall surface 342 are shown. The inclination angle B1 is an angle at which the inner wall surface 341 is inclined at an angle relative to the axial direction (B1<90 degrees). Similarly, the inclination angle B2 is an angle at which the inner wall surface 342 is inclined at an angle relative to the axial direction (B2<90 degrees). As illustrated in FIG. 5, the inclination angle B1 of the inner wall surface 341 is less than the inclination angle B2 of the inner wall surface 342 (B1<B2).

As illustrated in FIG. 1, in the mounted state, the annular protrusion portion 233 of the first resilient body 23 and the annular recess portion 323 of the second resilient body 32 engage with each other. Specifically, the annular recess portion 323 of the restricting member 30a engages with the annular protrusion portion 233a of the covering portion 231a, and the annular recess portion 323 of the restricting member 30b engages with the annular protrusion portion 233b of the covering portion 231b. Specifically, the outer wall surface 241 of the annular protrusion portion 233 is in contact with the inner wall surface 341 of the annular recess portion 323, and the outer wall surface 242 of the annular protrusion portion 233 is in contact with the inner wall surface 342 of the annular recess portion 323. The top portion 243 of the annular protrusion portion 233 and the bottom portion 343 of the annular recess portion 323 overlap as viewed in the axial direction.

As described above, the annular protrusion portion 233 of the first resilient body 23 and the annular recess portion 323 of the second resilient body 32 are engaged with each other, so that the restricting member 30 is mounted to the anti-vibration mount 20. In the first embodiment, the annular recess portion 323 for mounting the restricting member 30 to the anti-vibration mount 20 and the restriction region R for restricting the movement of the anti-vibration mount 20 are formed in the second resilient body 32, which is formed as a single piece. That is, the second resilient body 32 serves both for mounting the restricting member 30 and for restricting the anti-vibration mount 20. Therefore, the configuration of the restricting member 30 is simplified, as compared with a configuration in which an element for mounting the restricting member 30 to the anti-vibration mount 20 and an element for restricting the movement of the anti-vibration mount 20 are formed separately. By simplifying the configuration, manufacturing costs of the restricting member 30 can be reduced.

As shown in FIGS. 4 and 5, a groove portion 35 is formed in the facing surface 321 of the second resilient body 32 of the restricting member 30. The groove portion 35 is a recess extending along the circumferential direction in the facing surface 321. Specifically, the groove portion 35 is annularly continuous over the entire circumference of the facing surface 321. For example, the groove portion 35 is formed so as to overlap the connecting portion 313 of the support member 31 when viewed in the axial direction. That is, the groove portion 35 is located radially inward of the outer peripheral portion 312 when viewed in the axial direction.

As illustrated in FIG. 5, the groove portion 35 includes an inner wall surface 351 and an outer wall surface 352. The inner wall surface 351 is a frustoconical side surface inclined at an angle relative to the axial direction. The outer wall surface 352 is a frustoconical side surface inclined at an angle relative to the axial direction. A point at which the inner wall surface 351 and the outer wall surface 352 intersect with each other is a bottom portion 353 of the groove portion 35. As illustrated in FIGS. 4 and 5, the second resilient body 32 includes an annular portion (hereafter, an “inner peripheral portion 36”) located between the inner peripheral surface 322 and the inner wall surface 351 of the groove portion 35.

As shown in FIG. 5, the groove portion 35 is deeper than the axial position Z0 of the bottom portion 343 of the annular recess portion 323. That is, the depth D1 of the groove portion 35 is greater than the distance D2 between the facing surface 321 of the second resilient body 32 and the bottom portion 343 of the annular recess portion 323. The depth D1 of the groove portion 35 is the distance between the facing surface 321 of the second resilient body 32 and the bottom portion 353 of the groove portion 35.

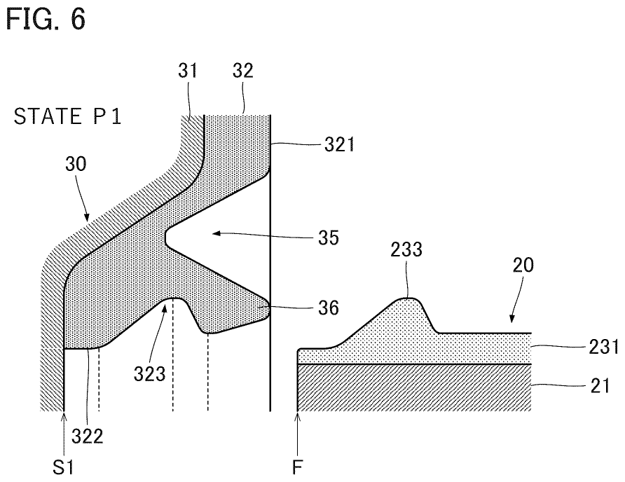

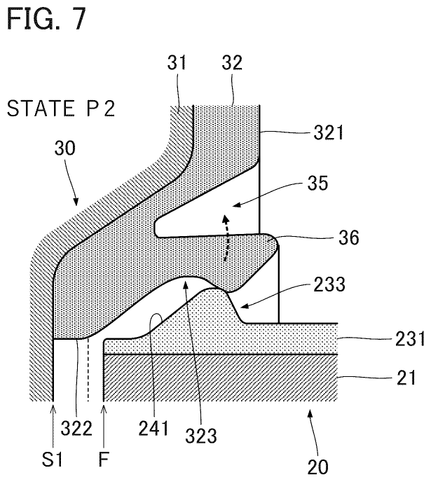

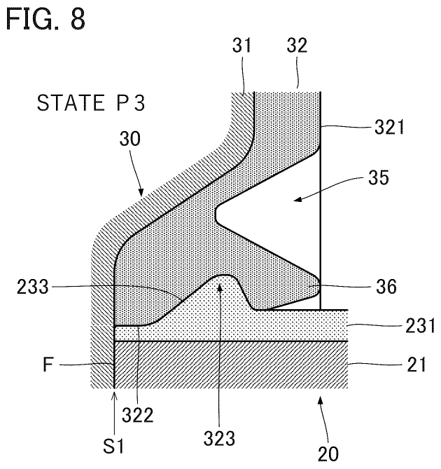

FIGS. 6 to 8 are explanatory views of a step of mounting the restricting member 30 to the anti-vibration mount 20. State P1 of FIG. 6 changes to state P3 of FIG. 8, via state P2 of FIG. 7.

In state P1 shown in FIG. 6, the restricting member 30 approaches the anti-vibration mount 20. In state P2 shown in FIG. 7, the inner peripheral portion 36 of the second resilient body 32 rides over the outer wall surface 241 of the annular protrusion portion 233 of the anti-vibration mount 20. In state P2, the inner peripheral portion 36 is deformed radially outward by a pressing force from the outer wall surface 241 of the annular protrusion portion 233, as illustrated by a broken-line arrow in FIG. 7. When the restricting member 30 approaches the anti-vibration mount 20 and the inner peripheral portion 36 passes over the annular protrusion portion 233, the restricting member 30 stops moving upon the first surface S1 of the restricting member 30 coming into contact with the end surface F of the anti-vibration mount 20, as shown in state P3 of FIG. 8. In a state in which the first surface S1 and the end surface F are in contact with each other, the annular protrusion portion 233 of the first resilient body 23 and the annular recess portion 323 of the second resilient body 32 are engaged with each other. As described above, since the annular protrusion portion 233 and the annular recess portion 323 are engaged with each other, the likelihood of the restricting member 30 becoming disengaged from the anti-vibration mount 20 can be reduced.

As described above, by the annular protrusion portion 233 of the first resilient body 23 and the annular recess portion 323 of the second resilient body 32 becoming engaged with each other, the restricting member 30 is mounted to the anti-vibration mount 20. Therefore, the dimensional accuracy requirement for the anti-vibration mount 20 and the restricting member 30 can be relaxed, as compared with a configuration in which the metal inner member 21 and the metal support member 31 are fitted to each other, for example.

In state P2 shown in FIG. 7, the inner peripheral portion 36 of the second resilient body 32 is deformed radially outward by the pressure from the annular protrusion portion 233. In the first embodiment, as described above, the groove portion 35 is formed in the facing surface 321 of the second resilient body 32. Therefore, the inner peripheral portion 36 of the second resilient body 32 can be easily deformed radially outward, as compared with a configuration in which the facing surface 321 is a flat surface without the groove portion 35 (hereinafter referred to as “comparative example”). That is, by forming the groove portion 35 in the second resilient body 32, engagement between the annular protrusion portion 233 and the annular recess portion 323 is facilitated. As described above, according to the first embodiment, the operation of mounting the restricting member 30 to the anti-vibration mount 20 can be facilitated.

In the first embodiment, in particular, the groove portion 35 is formed to have an annular shape. Therefore, the second resilient body 32 can be easily deformed over the entire circumference. In the first embodiment, the groove portion 35 is deeper than the axial position of the bottom portion 343 of the annular recess portion 323. Therefore, the second resilient body 32 can be easily deformed, as compared with a configuration in which the groove portion 35 is shallower than the axial position of the bottom portion 343 of the annular recess portion 323.

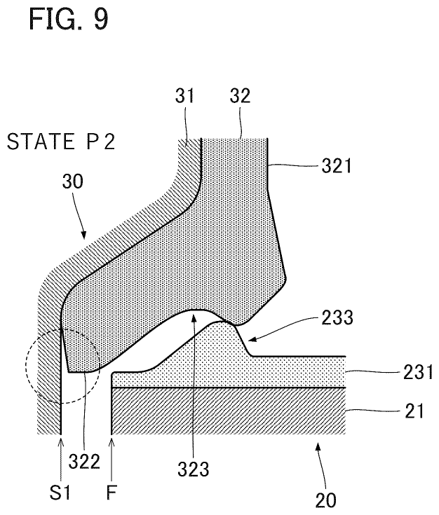

FIG. 9 is a cross-sectional view showing state P2 in which the restricting member 30 is in the process of being mounted and is partially mounted to the anti-vibration mount 20 according to the comparative example, in which the groove portion 35 is not formed in the second resilient body 32. Since the groove portion 35 is not formed in the second resilient body 32 in the comparative example, an excessive load is applied to the second resilient body 32 in state P2. Therefore, as illustrated by a broken line in FIG. 9, for example, the second resilient body 32 may be separated from the support member 31, starting at the boundary between the inner peripheral surface 322 of the second resilient body 32 and the first surface S1 of the support member 31. In order to prevent the separation, the second resilient body 32 needs to be bonded to the support member 31 with, for example, an adhesive.

In contrast to the comparative example, in the first embodiment, since the inner peripheral portion 36 is easily deformed by the configuration in which the groove portion 35 is formed in the second resilient body 32, it is possible to prevent or reduce an excessive load from acting on the second resilient body 32 over a wide area, in state P2. Therefore, according to the first embodiment, the likelihood of the second resilient body 32 being separated from the support member 31 in state P2 is reduced. As described above, since the likelihood of the separation of the second resilient body 32 is reduced, according to the first embodiment, it is possible to avoid the need for adhesion between the second resilient body 32 and the support member 31. Therefore, manufacturing costs are reduced as compared with the comparative example.

In the above description, focus is placed on the step of mounting the restricting member 30 to the anti-vibration mount 20, but substantially similar advantages can be realized also in the step of forming the restricting member 30 using a molding mold. For example, at a stage in which the molten material of the second resilient body 32 filled in the molding mold has cured, the restricting member 30 is released from the molding mold. In the process of releasing the restricting member 30, a load acts on the second resilient body 32. In the comparative example, there is a possibility that the second resilient body 32 will separate from the support member 31 during the releasing process. In contrast to the comparative example, however, in the first embodiment, since the groove portion 35 is formed in the second resilient body 32, it is possible to prevent or reduce an excessive load from being applied to a wide area of the second resilient body 32 in the process of releasing the restricting member 30. Therefore, the likelihood of the second resilient body 32 being separated can be reduced. That is, according to the first embodiment, good releasability, allowing the molded article to be released without causing damage thereto, can be achieved at the time of molding of the restricting member 30.

In the first embodiment, the inclination angle A1 of the outer wall surface 241 of the annular protrusion portion 233 is less than the inclination angle A2 of the outer wall surface 242. Therefore, compared with the configuration in which the inclination angle A1 exceeds the inclination angle A2, the load required to bring the restricting member 30 adjacent to the anti-vibration mount 20 in the step of mounting the restricting member 30 to the anti-vibration mount 20 is reduced. That is, the operation of engaging the annular protrusion portion 233 with the annular recess portion 323 can be facilitated. On the other hand, the inclination angle A2 of the outer wall surface 242 exceeds the inclination angle A1 of the outer wall surface 241. Therefore, as compared with a configuration in which the inclination angle A2 is less than the inclination angle A1, the restricting member 30 is less likely to be disengaged from the anti-vibration mount 20 in the mounted state in which the annular protrusion portion 233 and the annular recess portion 323 are engaged with each other. That is, it is possible to reduce the likelihood of the restricting member 30 being inadvertently disengaged from the anti-vibration mount 20.

In the first embodiment, the inclination angle B1 of the inner wall surface 341 in the annular recess portion 323 is less than the inclination angle B2 of the inner wall surface 342. Therefore, compared with a configuration in which the inclination angle B1 exceeds the inclination angle B2, the load required to bring the restricting member 30 adjacent to the anti-vibration mount 20 in the step of mounting the restricting member 30 to the anti-vibration mount 20 is reduced. That is, the operation of engaging the annular protrusion portion 233 with the annular recess portion 323 can be facilitated. On the other hand, the inclination angle B2 of the inner wall surface 342 exceeds the inclination angle B1 of the inner wall surface 341. Therefore, as compared with a configuration in which the inclination angle B2 is less than the inclination angle B1, the restricting member 30 is less likely to be disengaged from the anti-vibration mount 20 in the mounted state in which the annular protrusion portion 233 and the annular recess portion 323 are engaged with each other. That is, it is possible to reduce the likelihood of the restricting member 30 being inadvertently disengaged from the anti-vibration mount 20.

### B: Second Embodiment

A second embodiment will now be described. It is to be noted that, in the second embodiment illustrated below, elements of which the functions are the same as those of the first embodiment will be described with the same reference numerals as those of the first embodiment, and detailed descriptions thereof will be omitted as appropriate.

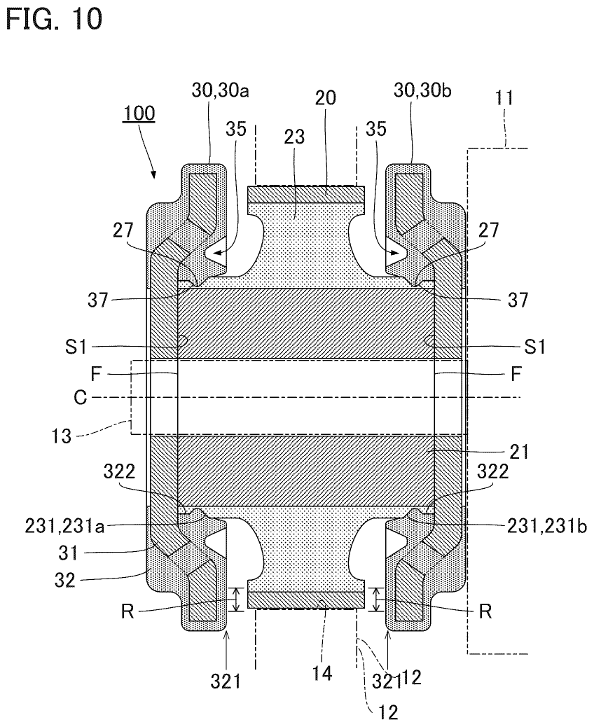

FIG. 10 is a cross-sectional view of the vibration isolation mechanism 100 according to the second embodiment. In the first embodiment, the annular protrusion portion 233 is formed in the first resilient body 23, and the annular recess portion 323 is formed in the second resilient body 32. In the second embodiment, as illustrated in FIG. 10, an annular recess portion 27 is formed in the first resilient body 23, and an annular protrusion portion 37 is formed in the second resilient body 32.

Specifically, the annular recess portion 27 is formed in the outer peripheral surface of the covering portion 231 of the first resilient body 23. The annular recess portion 27 is a recess extending along the circumferential direction. Specifically, the annular recess portion 27 is formed to have an annular shape that is continuous over the entire circumference of the covering portion 231. On the other hand, the annular protrusion portion 37 is formed in the inner peripheral surface 322 of the second resilient body 32. The annular protrusion portion 37 is a protrusion extending along the circumferential direction. Specifically, the annular protrusion portion 37 is formed to have an annular shape that is continuous over the entire circumference of the inner peripheral surface 322 of the second resilient body 32. By the annular recess portion 27 of the first resilient body 23 and the annular protrusion portion 37 of the second resilient body 32 becoming engaged with each other, the restricting member 30 is mounted to the anti-vibration mount 20.

In the second embodiment, the same effects as those of the first embodiment are attainable. In the second embodiment, as illustrated in FIG. 10, the covering portion 231 is thinned in the annular recess portion 27. Therefore, for example, in the step of molding the first resilient body 23 using a molding mold, the flow path becomes narrow at a portion of the molding mold corresponding to the annular recess portion 27, and consequently, the flow of the molten material of the first resilient body 23 is inhibited. In contrast to the second embodiment, in the first embodiment in which the annular protrusion portion 233 is formed in the first resilient body 23, since a sufficient flow path area is ensured in the portion of the molding mold corresponding to the annular protrusion portion 233, the flow of the material is hardly inhibited during molding of the first resilient body 23. Therefore, according to the first embodiment, as compared with the second embodiment, it is possible to prevent or mitigate problems such as molding defects caused by insufficient filling of the material in the molding mold.

The annular protrusion portion 233 in the first embodiment and the annular recess portion 27 in the second embodiment are comprehensively represented as a first engagement portion formed in the outer peripheral surface of the covering portion 231. Similarly, the annular recess portion 323 in the first embodiment and the annular protrusion portion 37 in the second embodiment are comprehensively expressed as a second engagement portion formed in the inner peripheral surface 322 of the second resilient body 32. As will be understood from the description of the first and second embodiments, the first and second engagement portions engage each other.

### C: Modifications

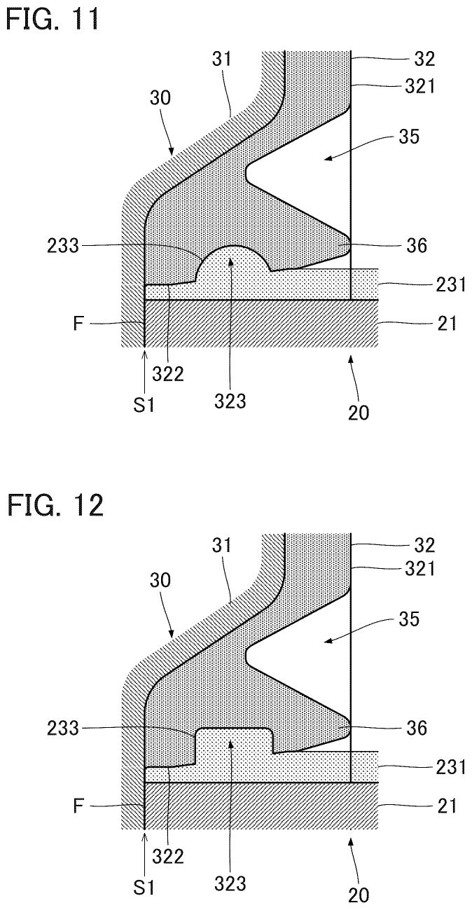

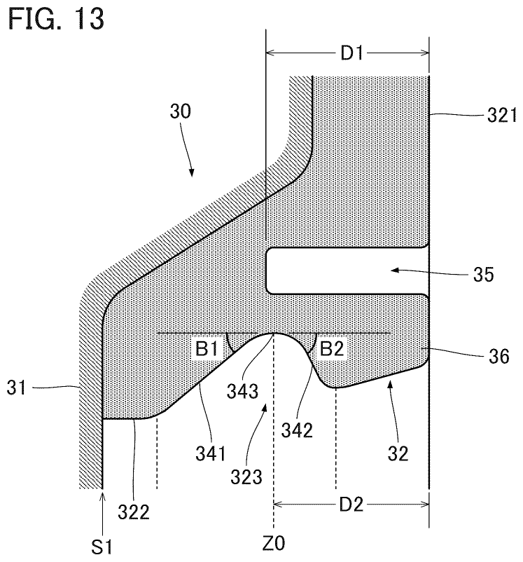

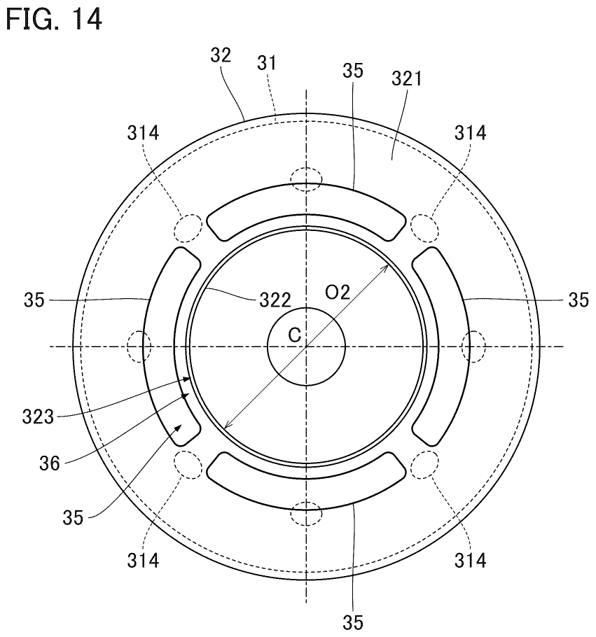

Examples of modifications that can be made to the embodiment described above will now be described. Two or more aspects freely selected from the following examples may be appropriately combined as long as they do not conflict with each other.
(1) The cross-sectional shape of the annular protrusion portion 233 formed in the first resilient body 23 and the cross-sectional shape of the annular recess portion 323 formed in the second resilient body 32 are not limited to the example shapes described in the first embodiment, and may be freely changed. For example, as illustrated in FIG. 11, the annular protrusion portion 233 and the annular recess portion 323 may have semicircular cross-sectional shapes. As illustrated in FIG. 12, the cross-sectional shapes of the annular protrusion portion 233 and the annular recess portion 323 may be rectangular. As will be understood from the above description, a configuration in which the inclination angle A1 of the outer wall surface 241 is less than the inclination angle A2 of the outer wall surface 242 in the first resilient body 23 and a configuration in which the inclination angle B1 of the inner wall surface 341 is less than the inclination angle B2 of the inner wall surface 342 in the second resilient body 32 may be omitted. In the above description, a modification based on the first embodiment has been exemplified, but similarly, for each of the annular recess portion 27 of the first resilient body 23 and the annular protrusion portion 37 of the second resilient body 32 in the second embodiment, the cross-sectional shape may be modified into a freely selected shape such as a semicircular shape or a rectangular shape.
(2) In each of the above-described embodiments, the cross-sectional shape of the groove portion 35 is a triangular shape defined by the inner wall surface 351 and the outer wall surface 352. However, the cross-sectional shape of the groove portion 35 is not limited to the example shape set out above, and may be freely changed. For example, as shown in FIG. 13, the cross-sectional shape of the groove portion 35 may be rectangular. Furthermore, in the above-described embodiments, the depth D1 of the groove portion 35 is greater than D2 between the facing surface 321 and the bottom portion 343 of the annular recess portion 323. However, the depth D1 of the groove portion 35 may be freely selected. For example, the depth D1 of the groove portion 35 may be less than the distance D2.
(3) In each of the above-described embodiments, the groove portion 35 is formed to have an annular shape over the entire circumference of the facing surface 321. However, the planar shape of the groove portion 35 is not limited to the above example. For example, as illustrated in FIG. 14, a plurality of arcuate groove portions 35 may be arranged in the circumferential direction at intervals from each other. That is, a configuration in which the groove portion 35 is annularly continuous in a plan view is not essential.
(4) In each of the embodiments described above, the vibration isolation mechanism 100 is applied to electric vehicles. However, the vibration isolation mechanism 100 may be applied to a freely selected object, and is not limited to electric vehicles. Accordingly, the use and structure of the first member 11 and the second member 12 to be subjected to the vibration isolation may be freely changed.
(5) The notation “n” (n is a natural number) in the present application is used only as a formal and convenient label for distinguishing each element by notation, and has no substantive meaning. Therefore, it does not restrict the interpretation of the position of each element, the order of manufacture, or the like on the basis of the notation “n”.

### D: Appendix

The following aspects are derivable from the embodiments described above.

A vibration isolation mechanism according to one aspect (aspect 1) of the present disclosure includes (a) an anti-vibration mount that includes: (i) an inner member into which a shaft member is to be inserted; (ii) an outer member surrounding the inner member; and (iii) a first resilient body that includes (1) a covering portion covering an outer peripheral surface of the inner member, (2) a connecting portion connecting the inner member with the outer member, and (3) a first engagement portion formed on an outer peripheral surface of the covering portion; and (b) a restricting member that includes: (i) a support member into which the shaft member is to be inserted; and (ii) a second resilient body provided on the support member, in which the second resilient body includes: (1) a facing surface including a restriction region that is spaced apart and faces an end surface of the outer member, (2) a groove portion formed in the facing surface and extending along a circumferential direction of the shaft member, (3) an inner peripheral surface facing the outer peripheral surface of the covering portion, and (4) a second engagement portion formed on the inner peripheral surface and engaging with the first engagement portion.

In the above aspect, the first resilient body can prevent or reduce transmission of vibration between the first member to which the shaft member is fixed and the second member to which the outer member is fixed. In addition, when the outer member is displaced in the axial direction relative to the inner member, the outer member comes into contact with the facing surface of the second resilient body, whereby the movement of the outer member in the axial direction is restricted. By the movement of the outer member being restricted, it is possible to reduce the likelihood of the first resilient body fracturing due to excessive deformation.

The first engagement portion of the first resilient body and the second engagement portion of the second resilient body are brought into engagement with each other, whereby the restricting member is mounted to the anti-vibration mount. Accordingly, for example, as compared with a configuration in which the inner member and the support member are fitted to each other, the dimensional accuracy requirements for the anti-vibration mount and the restricting member can be relaxed.

In addition, since the groove portion is formed in the facing surface of the second resilient body, the second resilient body is more likely to be deformed than a configuration in which the groove portion is not formed in the second resilient body. Specifically, a portion between the inner peripheral surface and the groove portion (hereafter, an “inner peripheral portion”) of the second resilient body is easily deformed. Therefore, the engagement between the first engagement portion and the second engagement portion is facilitated. That is, the operation of mounting the restricting member to the anti-vibration mount can be facilitated.

Furthermore, since the second resilient body is easily deformed due to the configuration in which the groove portion is formed in the second resilient body, it is possible to prevent or reduce an excessive load from acting on a wide area of the second resilient body. For example, the likelihood of the second resilient portion being separated from the support member due to the deformation of the second engagement portion can be reduced. Therefore, it is possible to eliminate the need for adhesion between the second engagement portion and the support member.

In an example (aspect 2) of aspect 1, the first engagement portion is an annular protrusion portion formed on the outer peripheral surface of the covering portion, and the second engagement portion is an annular recess portion formed in the inner peripheral surface of the second resilient body. In the above aspect, the restricting member is mounted to the anti-vibration mount by engaging the annular protrusion portion of the first resilient body with the annular recess portion of the second resilient body. In a configuration in which the first engagement portion is an annular recess portion, the annular recess portion of the covering portion is thin. Therefore, for example in the step of molding the first resilient body using a molding mold, the flow of the material of the first resilient body is inhibited in a portion corresponding to the annular recess of the molding mold. In the above-described configuration in which the first engagement portion is an annular protrusion portion, flow of the material is not significantly inhibited during molding of the first resilient body. Therefore, it is possible to prevent or mitigate problems such as molding defects.

In an example (aspect 3) of aspect 2, the annular protrusion portion includes a first outer wall surface located adjacent to the support member, and a second outer wall surface located away from the support member, and an inclination angle of the first outer wall surface relative to an axial direction of the shaft member is less than an inclination angle of the second outer wall surface relative to the axial direction of the shaft member. In the above aspect, of the annular protrusion portion of the first engagement portion, the inclination angle of the first outer wall surface is less than the inclination angle of the second outer wall surface. Therefore, compared with a configuration in which the inclination angle of the first outer wall surface exceeds the inclination angle of the second outer wall surface, the operation of engaging the annular protrusion portion of the first engagement portion with the annular recess portion of the second engagement portion can be facilitated. On the other hand, the inclination angle of the second outer wall surface exceeds the inclination angle of the first outer wall surface. Therefore, as compared with a configuration in which the inclination angle of the second outer wall surface is less than the inclination angle of the first outer wall surface, the restricting member is less likely to be disengaged from the anti-vibration mount in a mounted state in which the annular protrusion portion of the first engagement portion and the annular recess portion of the second engagement portion are engaged with each other. That is, it is possible to reduce the likelihood of the restricting member being inadvertently disengaged from the anti-vibration mount.

In an embodiment (aspect 4) of aspect 2 or aspect 3, the annular recess portion includes a first inner wall surface located adjacent to the support member, and a second inner wall surface located away from the support member, an inclination angle of the first inner wall surface relative to an axial direction of the shaft member is less than an inclination angle of the second inner wall surface relative to the axial direction of the shaft member. In the above aspect, the inclination angle of the first inner wall surface in the annular recess portion is less than the inclination angle of the second inner wall surface. Therefore, as compared with a configuration in which the inclination angle of the first inner wall surface exceeds the inclination angle of the second inner wall surface, the operation of engaging the annular protrusion portion of the first engagement portion with the annular recess portion of the second engagement portion can be facilitated. On the other hand, the inclination angle of the second inner wall surface exceeds the inclination angle of the first inner wall surface. Therefore, as compared with a configuration in which the inclination angle of the second inner wall surface is less than the inclination angle of the first inner wall surface, the restricting member is less likely to be disengaged from the anti-vibration mount in the mounted state in which the annular protrusion portion of the first engagement portion and the annular recess portion of the second engagement portion are engaged with each other. That is, it is possible to reduce the likelihood of the restricting member being inadvertently disengaged from the anti-vibration mount.

In an example (aspect 5) of any of aspects 2 to 5, the groove portion is deeper, in the axial direction of the shaft member, than a bottom portion of the annular recess portion. According to the above aspect, the second resilient body can be easily deformed as compared with a configuration in which the groove portion is shallower than the position of the bottom portion of the annular recess portion in the axial direction.

In an example (aspect 6) of any one of aspects 1 to 5, the groove portion is annular and formed in the facing surface. In the above aspect, the groove portion is formed to have an annular shape. Therefore, the deformation of the second resilient body can be facilitated over the entire circumferential direction.

According to another aspect (aspect 7) of the present disclosure, there is provided a vibration isolation mechanism including (a) a first restricting member; (b) a second restricting member; and (c) an anti-vibration mount between the first restricting member and the second restricting member, in which the anti-vibration mount includes: (i) an inner member into which a shaft member is to be inserted; (ii) an outer member surrounding the inner member; and (iii) a first resilient body that includes (1) a covering portion covering an outer peripheral surface of the inner member, (2) a connecting portion connecting the inner member with the outer member, and (3) a plurality of first engagement portions formed on an outer peripheral surface of the covering portion, each of the first restricting member and the second restricting member includes: (i) a support member into which the shaft member is to be inserted, and (ii) a second resilient body provided on the support member, the second resilient body includes: (1) a facing surface including a restriction region that is spaced apart and faces an end surface of the outer member; (2) a groove portion formed in the facing surface and extending along a circumferential direction of the shaft member; (3) an inner peripheral surface facing the outer peripheral surface of the covering portion, and (4) a second engagement portion formed on the inner peripheral surface, in which the second engagement portion of the first restricting member engages with, from among the plurality of first engagement portions, a first engagement portion located on one side of the connecting portion, and the second engagement portion of the second restricting member engages with, from among the plurality of first engagement portions, a first engagement portion located on another side of the connecting portion.

### DESCRIPTION OF REFERENCE SIGNS

100 . . . vibration isolation mechanism, 11 . . . first member, 12 . . . second member, 13 . . . shaft member, 14 . . . mounting hole, 20 . . . anti-vibration mount, 21 . . . inner member, 22 . . . outer member, 23 . . . first resilient body, 231 (231a,231b) . . . covering portion, 232 . . . connecting portion, 233 (233a,233b) . . . annular protrusion portion, 241 . . . outer wall surface, 242 . . . outer wall surface, 243 . . . top portion, 30(30a,30b) . . . restricting member, 31 . . . support member, 311 . . . base portion, 312 . . . outer peripheral portion, 313 . . . connecting portion, 314 . . . through hole, 32 . . . second resilient body, 321 . . . facing surface, 322 . . . inner peripheral surface, 323 . . . annular recess portion, 341 . . . inner wall surface, 342 . . . inner wall surface, 343 . . . bottom portion, 35 . . . groove portion, 351 . . . inner wall surface, 352 . . . inner wall surface, 353 . . . bottom portion, 36 . . . inner peripheral portion.

What is claimed is:

1. A vibration isolation mechanism comprising:
an anti-vibration mount that includes:
an inner member into which a shaft member is to be inserted;
an outer member surrounding the inner member; and
a first resilient body that includes a covering portion covering an outer peripheral surface of the inner member, a connecting portion connecting the inner member with the outer member, and a first engagement portion formed on an outer peripheral surface of the covering portion; and
a restricting member that includes:
a support member into which the shaft member is to be inserted; and
a second resilient body provided on the support member, wherein the second resilient body includes a facing surface including a restriction region that is spaced apart and faces an end surface of the outer member, a groove portion formed in the facing surface and extending along a circumferential direction of the shaft member, an inner peripheral surface facing the outer peripheral surface of the covering portion, and a second engagement portion formed on the inner peripheral surface and engaging with the first engagement portion.

2. The vibration isolation mechanism according to claim 1,
wherein the first engagement portion is an annular protrusion portion formed on the outer peripheral surface of the covering portion, and
wherein the second engagement portion is an annular recess portion formed in the inner peripheral surface of the second resilient body.

3. The vibration isolation mechanism according to claim 2,
wherein the annular protrusion portion includes,
a first outer wall surface located adjacent to the support member, and
a second outer wall surface located away from the support member, and
wherein an inclination angle of the first outer wall surface relative to an axial direction of the shaft member is less than an inclination angle of the second outer wall surface relative to the axial direction of the shaft member.

4. The vibration isolation mechanism according to claim 2,
wherein the annular recess portion includes,
a first inner wall surface located adjacent to the support member, and
a second inner wall surface located away from the support member, and
wherein an inclination angle of the first inner wall surface relative to an axial direction of the shaft member is less than an inclination angle of the second inner wall surface relative to the axial direction of the shaft member.

5. The vibration isolation mechanism according to claim 2, wherein the groove portion is deeper, in the axial direction of the shaft member, than a bottom portion of the annular recess portion.

6. The vibration isolation mechanism according to claim 1, wherein the groove portion is annular and formed in the facing surface.

7. A vibration isolation mechanism comprising:
a first restricting member;
a second restricting member; and
an anti-vibration mount between the first restricting member and the second restricting member,
wherein the anti-vibration mount includes:
an inner member into which a shaft member is to be inserted;
an outer member surrounding the inner member; and
a first resilient body that includes a covering portion covering an outer peripheral surface of the inner member, a connecting portion connecting the inner member with the outer member, and a plurality of first engagement portions formed on an outer peripheral surface of the covering portion,
wherein each of the first restricting member and the second restricting member includes:
a support member into which the shaft member is to be inserted; and
a second resilient body provided on the support member, wherein the second resilient body includes a facing surface including a restriction region that is spaced apart and faces an end surface of the outer member, a groove portion formed in the facing surface and extending along a circumferential direction of the shaft member, an inner peripheral surface facing the outer peripheral surface of the covering portion, and a second engagement portion formed on the inner peripheral surface, and
wherein the second engagement portion of the first restricting member engages with, from among the plurality of first engagement portions, a first engagement portion located on one side of the connecting portion, and
wherein the second engagement portion of the second restricting member engages with, from among the plurality of first engagement portions, a first engagement portion located on another side of the connecting portion.
